(19) United States
(12) Patent Application Publication
(10) Pub. No.: US 2011/0202691 A1
(43) Pub. Date: Aug. 18, 2011

(54) System circuit and method for software reload of peripheral devices

(76) Inventors: Ran Shalgi, Hod Hasharon (IL); Uri Shkolnik, Hofit (IL)

(21) Appl. No.: 12/929,649

(22) Filed: Feb. 7, 2011

(30) Foreign Application Priority Data
Feb. 12, 2010 (CN) 201010115835.3

(51) Int. Cl. G06F 3/00

(52) U.S. Cl. 710/14

(57) ABSTRACT

Disclosed is a method, circuit and system for facilitating software of firmware reload of a peripheral device. According to embodiments of the present invention, one or more circuit or modules on the peripheral device or on a host device may emulate normal peripheral operation when the peripheral device is engaged in a software/firmware reload operation.

### CROSS REFERENCE

The present application claims the benefit of Chinese Patent Application No. 201010115835.3 filed on Feb. 12, 2010, the disclosures of which are incorporated herein by reference.

### FIELD OF THE INVENTION

The present invention relates generally to the field of computers and computer peripheral devices. More specifically, the present invention relates to software reloading of detachable devices.

### BACKGROUND

Detachable (“hot plug”) devices (such as USB peripherals, SDIO dongles, PCI/e cards, and others) may use loadable software (also known sometimes as “firmware”), which is loaded during the device boot-up session and/or at other times during the device's operation.

This software also determines the device's capabilities.

Sometimes there is a need to replace the existing software with some other software, either for upgrading the existing software, or for replacing it with a different software that significantly changes the device's capabilities (such as from a TV receiver device to a mass storage device, or any other change).

### SUMMARY OF THE INVENTION

The present invention is a system and method for software reloading of detachable or peripheral devices, for example Universal Serial Bus (“USB”) devices. According to some embodiments of the present invention, a host interface integral with or otherwise functionally associated with the detachable/peripheral device may emulate (e.g. fake) normal operation of the device and may answer any communications from a device driver (e.g. requests) by pretending the device is operating correctly while the device is in fact reloading operating software or firmware, for example new operating software/firmware.

According to further embodiments of the present invention, the device driver on a host computer may fake normal operation and answer any host requests pretending the device is operating correctly while it is in fact reloading new software.

According to some embodiments, there may be provided a circuit associated with a peripheral device host interface which may include communication logic adapted to communicate with a host device as if the device were operational when the peripheral is in an inoperative state. The communication logic may be adapted to communicate with a host device as if the peripheral where operational when the peripheral is loading operating software or firmware. The communication logic may be adapted to enter a reload mode when software or firmware is being loaded to the peripheral and to respond to a host access request as if the peripheral is operational. The communication logic may be adapted to enter a normal operating mode and to facilitate communication between the host and the peripheral when software or firmware loading to the peripheral is complete.

According to some embodiments of the present invention, there may be provided a peripheral device which may include a host interface adapted to communicate with a host device as if the device where operational when the device is in an inoperative state. The interface may be adapted to communicate with a host device as if the device where operational when the device is loading operating software or firmware. The interface may be adapted to enter a reload mode when software or firmware is being loaded to the peripheral and to respond to a host access request as if the peripheral is operational. The interface may be adapted to enter a normal operating mode and to facilitate communication between the host and the peripheral when software or firmware loading to the peripheral is complete. The peripheral may include at least two code memory locations.

According to some embodiments of the present invention, there may be provided a peripheral device interface module adapted to reside on a host device and may include communication logic adapted to communicate with a host device process as if the peripheral where operational when the peripheral is in an inoperative state. The communication logic may be adapted to communicate with a host device process as if the peripheral were operational when the peripheral is loading operating software or firmware. The communication logic may be adapted to enter a reload mode when software or firmware is being loaded to the peripheral and to respond to a host process access request as if the device is operational. The communication logic may be adapted to enter a normal operating mode and to facilitate communication between the host process and the peripheral when software or firmware loading to the peripheral is complete.

According to embodiments, a host device may include a peripheral device interface module including communication logic that is adapted to communicate with a host device process as if the peripheral were operational when the peripheral is loading operating software or firmware. The communication logic may be adapted to enter a reload mode when software or firmware is being loaded to the peripheral and to respond to a host process access request as if the peripheral is operational. The communication logic may be adapted to enter a normal operating mode and to facilitate communication between the host process and the peripheral when software or firmware loading to the peripheral is complete.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a basic configuration of an exemplary embodiment of the present invention;

FIG. 2 shows a schematic diagram of an exemplary host device driver connected to the device's host interface according to some embodiments of the present invention;

FIG. 3 is a flowchart of an exemplary reload process with the device emulating or mimicking normal operation according to some embodiments of the present invention;

FIG. 4 is a flowchart of another exemplary reload process with the device emulating or mimicking normal operation according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Current implementations of software reload may include various mechanisms, for example, resetting the device and loading the new software during the consequent boot-up session, program the device flash memory and re-boot the device, and other mechanisms. All current mechanisms may involve resetting, and/or re-initializing, and/or other operations which may involve host interface, which may be detected by the host operating system, which may cause a chain of events that may be determined by the involved host's operational definitions.

There may be various disadvantages that such device interface events may cause, some may be generic, as system to user plug-in and plug-out notifications (including audible and visual), also, there may be device manager applications which these auto-refresh procedures may initiate causing system and GUI modifications.

File-system devices issue events that may cause the file manager utilities to alter their state and user perspectives may change. Streaming media players and other stream based applications (audio, video, p2p utilities and many more) which may be bound to such a device, may detect such a device as termination indications, or other significant event.

According to one embodiment of the present invention there may be a system for software reload of a detachable device from a host computer while and during the device's operation, and which may not need to restart and/or reboot and/or reset the host computer and/or any process and/or interface device driver in the host computer. The software reload may be done in a seamless, transparent or otherwise smooth way which may ensure seamless host operation.

According to embodiments of the present invention, there may be provided methods, circuits and system for transparent software reload of a detachable/peripheral device from a host computer, in a manner in which no entity in the host, other than the specific host device driver entity, may detect that a software reload operation is/has taken place in the detachable/peripheral device. According to embodiments of the present invention, events and/or event notifications may be avoided by having a host controller or logic associated therewith emulate normal device operation when the device is loading or reloading operating software/shareware.

According to some embodiments of the present invention, the host interface in the detachable device may emulate or fake normal operation and answer any device driver requests, pretending the device is operating correctly while the device is in fact reloading new software.

According to some other embodiments of the present invention the device driver in the host computer may emulate or fake normal operation and answer any host requests pretending the device is operating correctly while the device is in fact reloading new software. According to some embodiments of the present invention, there may be a device driver that may have two modes of operation, the first mode of operation may be a working mode, and the second mode of operation may be a reload mode. According to some embodiments of the present invention, in the working mode the device driver may operate normally and may regulate communication between the host and the removable/peripheral device in a regular operating form. According to some embodiments of the present invention, in the reload mode the device driver may emulate or fake the normal mode of operation towards the host and answer correctly any host access that may take place, while performing or otherwise facilitating the reload of the new software to the device. According to some other embodiments of the present invention, there may be provided a device that may have two modes of operation, the first mode of operation may be a working mode, and the second mode of operation may be a reload mode. According to some embodiments of the present invention, in the working mode the device's host interface (hardware and software) may operate normally and may communicate with the host in a regular operating form. According to some embodiments of the present invention, in the reload mode the device host interface and/or logic circuits functionally associated therewith may fake a normal mode of operation towards the host and/or device drivers running thereon, and may answer correctly any host access requests that may take place.

According to some embodiments of the present invention, the device, upon software download process initialization, may set the host interface (hardware and/or software) to answer correctly any host access requests that may take place during the software download process as if the device is still operational, and only then may perform any operation that may be required for software reload, including replacing the code memory (such as RAM and/or the ROM and/or FLASH memory and/or any other means of code storage), re-initializing any required device components, or re-booting the device. According to some embodiments of the present invention, after the software download is complete, the device may be re-initialized and the host interface may be re-activated to its normal operation mode and re-bound to the new software that may be running on the device.

According to some embodiments of the present invention, the device may have two code memory blocks, a first memory block and a second memory block. The code may run from the active memory block which may be the first memory block or the second memory block, and the new code may be reloaded to the alternative memory block which may be the second memory block or the first memory block accordingly. According to some embodiments of the present invention, the new code may be reloaded to the alternative memory block while the device keeps operating normally and running from the active memory block. According to some embodiments of the present invention, after the software was downloaded to the alternative memory the device may set the host interface (hardware and/or software) to answer correctly any host access requests that may take place and then may re-initialize any required device components, or re-boot the device after which the host interface may be re-activated to its normal operation mode and re-bound to the new software that may now run on the alternative memory block of the device. According to some other embodiments of the present invention, after the software was downloaded to the alternative memory, the device may set the host interface (hardware and/or software) to answer correctly any host access that may take place. The new software may then be copied to the first memory and any required device components may be re-initialized or the device may re-boot after which the host interface may be re-activated to its normal operation mode and re-bound to the new software that may run on the first memory block of the device. According to some other embodiments of the present invention, the device may set the host interface (hardware and/or software) to answer correctly any host access that may take place, after which, the software may be downloaded to the first memory and replace the existing software. After the software download, any required device components may be reinitialized or the device may perform a re-boot and then the host interface may be re-activated to its normal operation mode and re-bound to the new software that may be running from the first memory block of the device.

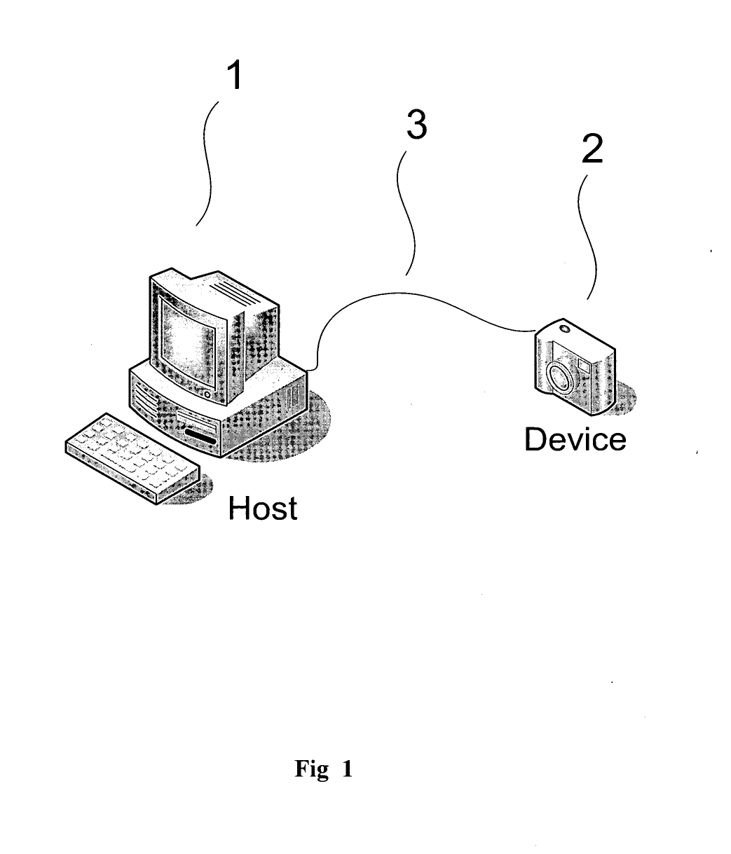

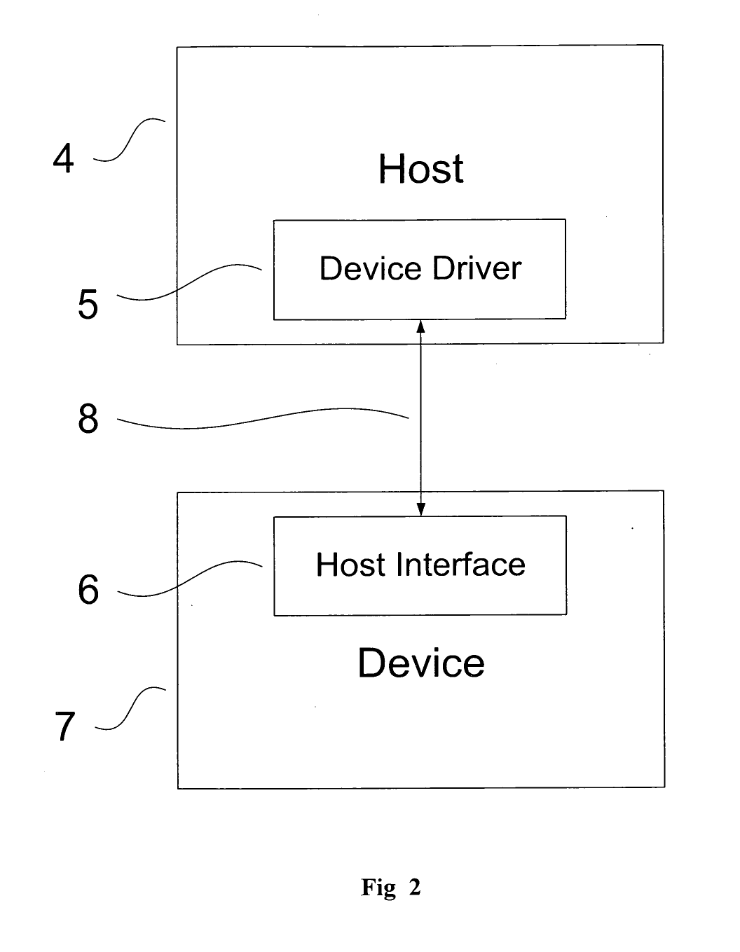

FIG. 1 shows an exemplary configuration according to some embodiments of the present invention, including a a device (2) connected to a host computer (1). The device (2) may be connected to the host computer (1) through a cable (3), or the device may be plugged directly to the host computer. In FIG. 2, a logical diagram of the host (7) and the device (4) are shown. The host interface (6) in the device (4) may communicate with the device driver (5) in the host (7) over a link (8). The link (8) may include software messages and/or hardware signaling.

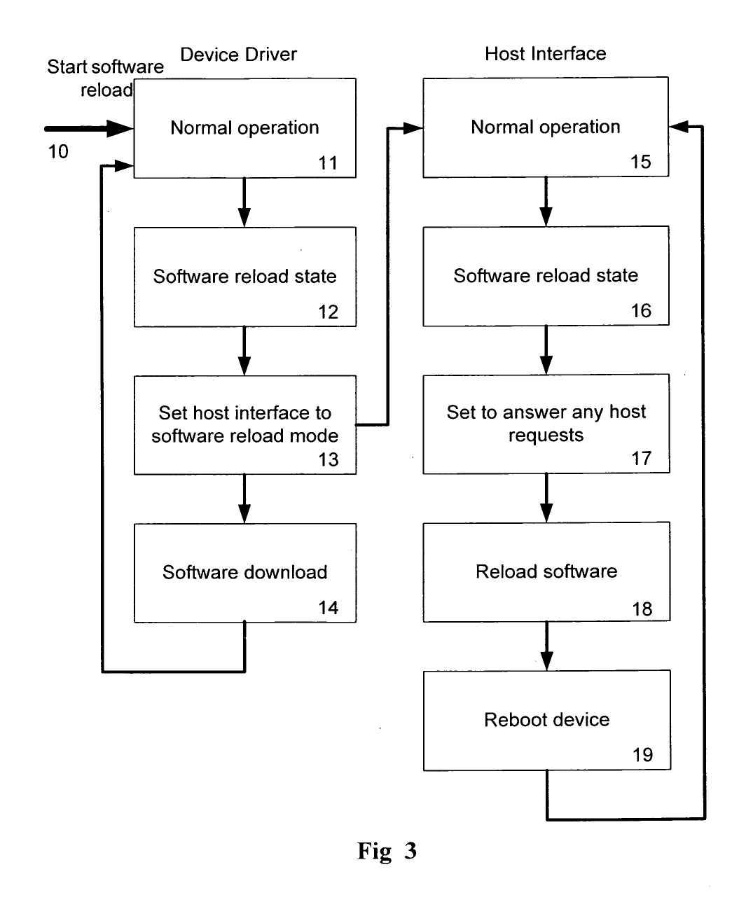

FIG. 3 is an exemplary flowchart according to one embodiment of the present invention, of the steps that may occur in the host interface and in the device driver, and the relationship between them. According to this embodiment, the host interface may fake normal operation towards the host and may answer correctly any software and/or hardware host requests during software reload operation.

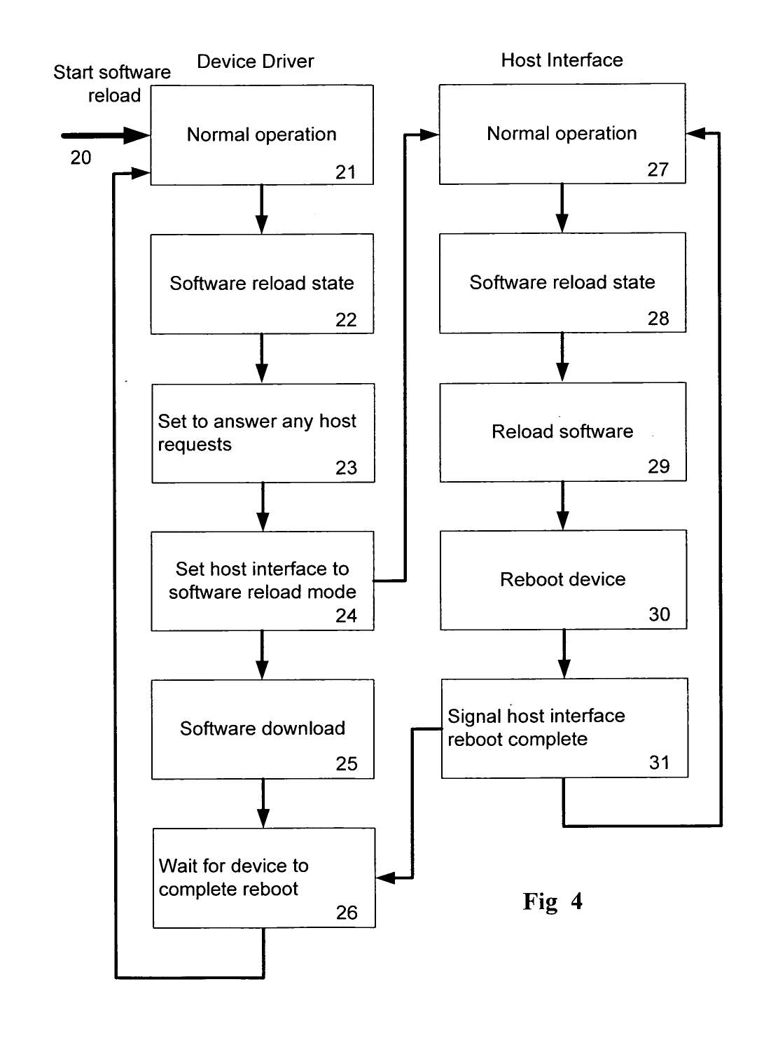

FIG. 4 is an exemplary flowchart according to another embodiment of the present invention, of the steps that occur in the host interface and in the device driver, and the relationship between them. According to this embodiment the device driver may fake normal operation towards the host and may answer correctly any host requests during software reload operation.

In the case when the host interface may fake normal operation (FIG. 3), upon software reload command from the host (10), the device driver may exit normal operation state (11) and transition to software reload state (12) after which it may send a command to the device to enter software reload mode (13). Upon receiving the software reload command from the device driver, the host interface may transition from normal operation state (15) to software reload state (16). The host interface may then answer correctly any host requests (fake normal operation) (17). The device driver and the host interface may then perform the software download, states 14 and 18 respectively. Upon completion of the software download, the host interface may reinitialize any part of the device that may need to be initialized (19) and the device driver and host interface may return to normal operation mode 11 and 15 respectively.

In the case when the device driver may fake normal operation (FIG. 4), upon software reload command from the host (20), the device driver may exit normal operation state (21) and transition to software reload state (22). The device driver may then be set to answer correctly any host requests (fake normal operation) (23) after which it may command the device to enter the reload mode state (24). Upon receiving the command from the device driver, the host interface may transition from normal operation state (27) to the software reload state (28). The device driver and the host interface may then perform the software download states 25 and 29 respectively. Upon completion of the software download, the host interface may reinitialize any part of the device that may need to be initialized (30) while the device driver is waiting for the device to complete the re-initialization process in the wait state (16). Upon re-initialization completion, the host interface may signal the device driver that re-initialization has been completed (31) and the device driver and host interface may return to normal operation mode 21 and 27 respectively.

According to an embodiment of the present invention there may be a method for software reload of a detachable device from a host computer, while and during the device's operation and which may not need to restart or reboot the host computer and/or any process and/or any device driver in the host computer. The software reload may be done in a smooth way which may ensure seamless operation of the host.

According to another embodiment of the present invention there may be a method for transparent software reload of a detachable device from a host computer, in a way that no entity in the host, other than the specific host device driver entity, may detect that a software reload operation is taking place, and as a result, no chain of events, caused by the host interface event, may be triggered.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A circuit associated with a peripheral device host interface comprising:
communication logic adapted to communicate with a host device as if the device were operational when the peripheral is in an inoperative state.

2. The circuit according to claim 1, wherein said communication logic is adapted to communicate with a host device as if the peripheral where operational when the peripheral is loading operating software or firmware.

3. The circuit according to claim 2, wherein said communication logic is adapted to enter a reload mode when software or firmware is being loaded to the peripheral and to respond to a host access request as if the peripheral is operational.

4. The circuit according to claim 3, wherein said communication logic is adapted to enter a normal operating mode and to facilitate communication between the host and the peripheral when software or firmware loading to the peripheral is complete.

5. A peripheral device comprising:
a host interface adapted to communicate with a host device as if the device where operational when the device is in an inoperative state.

6. The peripheral device according to claim 5, wherein said interface is adapted to communicate with a host device as if the device where operational when the device is loading operating software or firmware.

7. The peripheral according to claim 6, wherein said interface is adapted to enter a reload mode when software or firmware is being loaded to the peripheral and to respond to a host access request as if the peripheral is operational.

8. There peripheral according to claim 7, wherein said interface is adapted to enter a normal operating mode and to facilitate communication between the host and the peripheral when software or firmware loading to the peripheral is complete.

9. The peripheral according to claim 5, further comprising at least two code memory locations.

10. A peripheral device interface module adapted to reside on a host device and comprising:
communication logic adapted to communicate with a host device process as if the peripheral where operational when the peripheral is in an inoperative state.

11. The module according to claim 10, wherein said communication logic is adapted to communicate with a host device process as if the peripheral were operational when the peripheral is loading operating software or firmware.

12. The module according to claim 11, wherein said communication logic is adapted to enter a reload mode when software or firmware is being loaded to the peripheral and to respond to a host process access request as if the device is operational.

13. The module according to claim 12, wherein said communication logic is adapted to enter a normal operating mode and to facilitate communication between the host process and the peripheral when software or firmware loading to the peripheral is complete.

14. A host device comprising:
a peripheral device interface module including communication logic that is adapted to communicate with a host device process as if the peripheral were operational when the peripheral is loading operating software or firmware.

15. The host according to claim 14, wherein said communication logic is adapted to enter a reload mode when software or firmware is being loaded to the peripheral and to respond to a host process access request as if the peripheral is operational.

16. The host according to claim 15, wherein said communication logic is adapted to enter a normal operating mode and to facilitate communication between the host process and the peripheral when software or firmware loading to the peripheral is complete.
